(19) United States
(12) Patent Application Publication
(10) Pub. No.: US 2006/0246340 A1
(43) Pub. Date: Nov. 2, 2006

(54) Sealed fuel cell unit with a proton-exchange membrane

(75) Inventors: Riqing Zhang, Shenzhen (CN); Rui Liu, Shenzhen (CN); Junqing Dong, Shenzhen (CN)

Correspondence Address: EMIL CHANG;LAW OFFICES OF EMIL CHANG, 874 JASMINE DRIVE, SUNNYDALE, CA, 94086, US

(73) Assignee: BYD Company Limited

(21) Appl. No.: 11/412,726

(22) Filed: Apr. 26, 2006

(30) Foreign Application Priority Data
Apr. 30, 2005 (CN) 200510020840.5

(51) Int. Cl. H01M 8/02; H01M 8/10; H01M 2/08; H01M 4/96

(52) U.S. Cl. 429/35; 429/30; 429/44

(57) ABSTRACT

A sealed proton-exchange membrane fuel cell unit of this invention comprises an MEA component, a sealing unit, and current collectors for the positive and negative electrodes. The current collectors press the MEA components from each side. The MEA components comprise a proton-exchange membrane, a sealing unit, and the positive and negative electrodes attached to each side of the membrane. A sealing unit cover the edges of the proton-exchange membrane. First positioning units are located on each side of said sealing unit facing the respective current collectors of the negative and positive electrodes. At the corresponding locations on the current collectors of the negative and positive electrodes there are second positioning units. The first and second positioning units correspondingly match each other. First positioning units can be convex in shape on the surface of the sealing units. The second positioning units can be sealing grooves formed by cutting on the surface of the current collectors facing the MEA component. By matching the locations of the first and second positioning units, the negative and positive current collectors are not likely to slide against each other. Thus the cell is more tightly sealed, achieving better air-tightness.

### CROSS REFERENCE

This application claims priority from a Chinese patent application entitled “A Sealed Frame for A Fuel Cell Unit with A Proton-Exchange Membrane” filed on Apr. 30, 2005, having a Chinese Application No. 200510020840.5. This application is incorporated herein by reference in its entirety.

### FIELD OF INVENTION

This invention relates to the field of fuel cells, and, in particular, it relates to sealed fuel cell units with proton-exchange membranes.

### BACKGROUND

Fuel cells are a type of reactions device which directly convert the chemical energy in fuel and oxidant to electrical energy. Fuel cells, and especially fuel cells with proton-exchange membranes, have the advantages of a low level of noise, high energy conversion efficiency, lack of pollution, etc. Fuel cells are an ideal future source of electricity. They can be used in miniature portable power sources, residential miniature power generators, or the power sources of electric cars.

In fuel cells, generally there are membrane electrode assemblies (MEAs), current collectors, and sealing units. Here, the MEAs are the core component of fuel cells. They provide the electrochemical reactions with active materials. Current collectors are engraved with gas channels which provide the gas flow field. At the same time, the current collectors provide the MEAs with support and transmit electrons thus their functions are very important. There is an issue of sealing between the current collectors and an MEA. Poor sealing can cause gas leakage or mixing of gases of the negative and positive electrodes, leading to hazards. Therefore, the sealing unit is also among the key technologies.

As shown in FIG. 1, in the current fuel cells with proton-exchange membranes, a proton-exchange membrane 7 in the MEAs extends significantly beyond an electrochemically active area 8 so that the fuel gases are separated from the oxidizing gases, preventing them from being mixed together. At the same time, the proton-exchange membrane 7 separates the current collectors 9 preventing them from short circuiting though contacts. Sealing grooves are engraved around the reacting gas channels on the two current collectors 9. Sealing gaskets 10 are fitted into the two sealing grooves. Generally, the two sealing gaskets 10 rise somewhat above the surface of the current collectors 9. When the fuel cells are being assembled, the MEAs are placed between two current collectors having sealing gaskets 10. Mechanical force is applied to tightly clamp the two current collectors so that a sealing gasket 10, a proton-exchange membrane 7, and the sealing gasket 10 on the other current collector are pressed together to achieve sealing. This design of sealing has the flowing disadvantages: (1) the proton-exchange membrane 7 must extend beyond the sealing gasket 10 thus a large amount of proton-exchange membranes must be used, incurring high manufacturing costs for the cells; (2) the proton-exchange membranes are gas membranes, and being pressed between the sealing gasket 10 and the current collector 9 for a long period of time can cause it to age and break which may easily lead to mixing the gases of the positive and negative electrodes and cause hazards.

To solve the above problem, better sealed fuel cell units have been designed. Among them is Chinese utility model patent with a publication number 2475144Y published on Jan. 30, 2002, titled “Sealing Frames for Fuel Cell Units.” The disclosed sealing frames comprise MEAs and the current collectors clamping them. The MEAs comprise of components “A” and “B.” “A” is made by pressing proton-exchange membranes, catalysts, and porous carbon paper together. The porous carbon paper of component “A” is equivalent to the proton-exchange membrane in length or 1-10 mm shorter. Component “B” is a cover frame, and component “A” and “B” are combined to form a complete MEA. Sealing rims are installed around the edges of said current collectors. Alternatively, sealing rims are installed at component “B.” The current collectors adhere to each other with said MEA in between to form a sealed frame of a fuel cell unit. However, that sealing frame has the following disadvantages: (1) The sealing rims are installed on the current collectors. When the cell is being assembled, the raised sealing rims of the two current collectors or the rigid parts press component “B”, making it difficult for the current collectors to be aligned with each other. Even if they can be aligned with each other, the balance is unstable, making it easy for the two current collectors to be misaligned. (2) If sealing is achieved by using a surface or a line and a sealing rim, the sealing rim will age after being used over a long period of time. It is going to lose its elasticity and can easily cause a gas leakage.

Another sealing structure is disclosed by Chinese Patent 1567612A, published on Jan. 19, 2005, titled “A Sealing Structure for Fuel Cells.” According to that sealing structure, sealing pads are inserted at the edges where the separating plates are combined with the MEAs. On the two sides of the sealing pads, there are concaves along the long edge of the upper edge. Thus the sealing pads can tightly adhere to the plates without losing elasticity and maintain air-tightness. However, the sealing structure has the following disadvantages: (1) Since the sealing pads are inserted between the separating plates and the MEAs, it is difficult to align the two separating plates. Even if they are aligned, they can be easily misaligned. (2) The the sealing pads and the separating plates are connected along a line or a surface. The sealing pads will age and lose its effect after being used for a long period of time and cause a gas leakage.

### SUMMARY OF THE INVENTION

An object of this invention is to provide a type of proton-exchange membrane fuel cell unit with good air-tightness.

Briefly, a presently preferred embodiment of the present invention comprises a sealed proton-exchange membrane fuel cell unit having an MEA component, a sealing unit, and current collectors. The current collectors for the positive and negative electrodes can press the MEA components from each side. The MEA component can comprise a proton-exchange membrane and positive and negative electrodes which can be attached to each side of the membrane. The sealing unit can cover an edge of the proton-exchange membrane and can be bound to the edge. A first positioning unit can be located on a side of said sealing unit facing a current collector of the negative or positive electrode. At the corresponding location on the current collector of the negative or positive electrode there is a second positioning unit. The first and the second positioning units match each other.

An advantage of the present invention is that by matching the locations of the first and second positioning units, the negative and positive current collectors are not likely to slide against each other, and thus the cell is more tightly sealed, achieving better air-tightness.

Another advantage of the present invention is that due to the structure of having convex shaped first positioning units on each side of the sealing units and sealing grooves on the current collectors, when the cell is being assembled, the positions of the current collectors allow the cells to be easily assembled and the current collectors can be easily aligned to each other.

Yet another advantage of the present invention is that due to the elasticity of the sealing units and that the proton-exchange membrane does not extend beyond the sealing units, the use of the proton-exchange membrane is reduced and the costs of the cells are lowered. Furthermore, the aging of the sealing units is slowed and the life-span of the cells is extended.

### FIGURES

The following are further descriptions of the invention with reference to figures and examples of their applications.

FIG. 1 is an illustration of a cross-section of the sealing frames for fuel cell units with proton-exchange membranes.

FIG. 2 is an illustration of a cross-section of a sealed proton-exchange membrane fuel cell unit of Embodiment 1.

FIG. 3 is a top view of Embodiment 1.

FIG. 4 is an illustration of a cross-section of a sealed proton-exchange membrane fuel cell unit of Embodiment 2.

FIG. 5 is an illustration of a cross-section of a sealed proton-exchange membrane fuel cell unit of Embodiment 3.

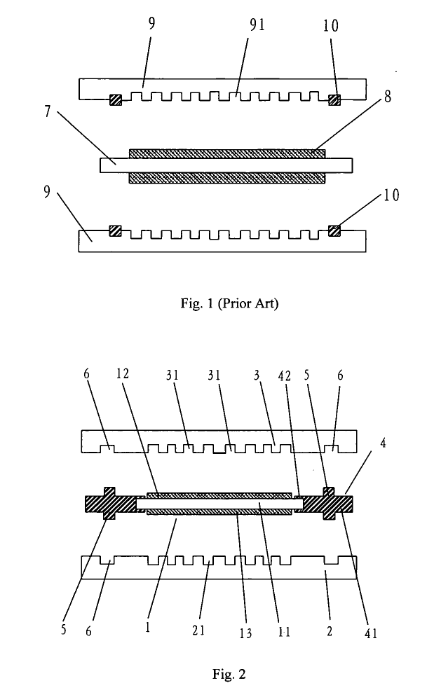

### DETAILED DESCRIPTIONS OF THE PREFERRED EMBODIMENTS

A presently preferred embodiment of the present invention comprises a sealed proton-exchange membrane fuel cell unit having an MEA component, a sealing unit, and current collectors. The current collectors for the positive and negative electrodes can press the MEA components from each side. The MEA component can comprise a proton-exchange membrane and positive and negative electrodes which can be attached to each side of the membrane. The sealing unit can cover an edge of the proton-exchange membrane and can be bound to the edge. A first positioning unit can be located on a side of said sealing unit facing a current collector of the negative or positive electrode. At the corresponding location on the current collector of the negative or positive electrode there is a second positioning unit. The first and the second positioning units match each other.

The first and second positioning units can exactly match or otherwise. The first positioning units can be convex in shape on the surface of the sealing units. The second positioning units can be sealing grooves formed by cutting on the surface of the current collectors facing the MEA component.

The convex shapes can be arc-shaped, polygonal-shaped, elliptical-shaped, or subulate-shaped. The sealing grooves are shaped to match that of the convex shapes.

The top of the convex can be above the surface of the MEA component. The first positioning units can be slightly oversized for the sealing grooves.

Said negative and positive electrodes can be porous carbon paper or carbon cloth. Along the long edge of the electrodes, the proton-exchange membrane can be longer than the porous carbon paper or carbon cloth by 0.1%-80%.

The sealing units can be elastomer, and the MEA components and sealing units can be bound together.

Grooves can exist where said sealing units join the proton-exchange membranes. The edges of the proton-exchange membrane can be fixed in the grooves.

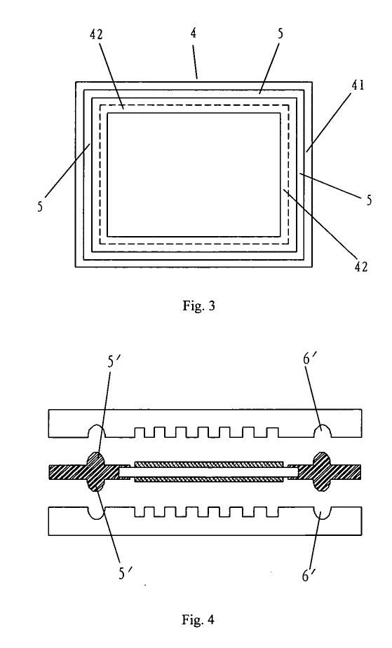

With references to FIGS. 2-5, a sealed proton-exchange membrane fuel cell unit of this invention comprises an MEA component 1, a current collector 2 for the negative electrode, and a current collector 3 for the positive electrode. The current collectors press the MEA component from each side. The MEA component 1 comprises a proton-exchange membrane 11, a negative electrode 13, and a positive electrode 12. The electrodes are attached to each side of the membrane along the long edge. The proton-exchange membrane is made of macromolecular materials, such as the current Nafion membrane of the Dupont company. The positive electrode 12 and the negative electrode 13 are both made of conductive materials. In this embodiment, the positive electrode 12 and the negative electrode 13 are porous carbon paper or carbon cloth. Along the long edge of the proton-exchange membrane 11, the membrane is longer than the porous carbon paper or carbon cloth by 0.1%-80%.

On a side of the current collector 2 of the negative electrode and a side of the current collector 3 of the positive electrode facing MEA component 1, there are a few flowpaths 21, 31. Thus a flow field for the fuel gases is formed between current collector 3 of the positive electrode. A flow field for the oxidizing gas is formed between the current collector 2 of the negative electrode and the MEA component 1. The current collector 2 of the negative electrode and the current collector 3 of the positive electrode provide support and perform the function of conducting electrons for the MEA component at the same time. The length of the current collector 2 of the negative electrode and the length of the current collector 3 of the positive electrode are greater than that of the proton-exchange membrane 11.

The sealed fuel cell unit also comprises a sealing unit 4. The sealing unit 4 covers the edges of the proton-exchange membrane 11. The sealing unit 4 can be roughly rectangular, including a rectangular base 41, and a first positioning unit 5. The groove 42 is located where the base 41 joins the edges of the proton-exchange membrane 11. The groove 42 and the edges of the proton-exchange membrane can exactly match or be tightly fitted. Thus sealing unit 4 is fitted around the proton-exchange membrane 11. Furthermore, on the side of the sealing unit 4 facing the current collector 2 of the negative electrode, there is a first positioning unit, and on the side of the sealing unit 5 facing current collector 3 of the positive electrode, there is also a first positioning unit 5. In this embodiment, the first positioning unit 5 is convex in shape pointing to a current collector. The sealing unit 4 is made of elastic and non-corrosive materials, such as thermosetting materials including silicone, etc. It can also be made of rubber or polyurethane, etc. During manufacturing, the sealing unit 4 may be formed by a one-time hot press process. The MEA component 1 is formed by pressing the proton-exchange membrane 11, the negative electrode 13, and the positive electrode 12 together. Then the MEA component 1 and the sealing unit 4 are pressed together to form a single unit.

The second positioning unit 6 is located on the current collector 2 and the current collector 3 of the negative and positive electrodes. The location of the positioning unit 6 corresponds to that of the first positioning unit 5. The first positioning unit 5 is located on the sealing unit 4. The first positioning unit 5 and the second positioning unit 6 match each other. Preferably, the size and shape of the first positioning unit 5 and the second positioning unit 6 match each other. In this embodiment, the second positioning unit 6 is a sealing groove on the current collector 2 of the negative electrode facing the MEA component 1 and on the current collector 3 of the positive electrode also facing the MEA component 1.

As the sealed fuel cell unit of this invention is assembled, the current collector 2 of the negative electrode and the current collector 3 of the positive electrode press the MEA component 1 from each side. The first positioning unit 5 of the sealing unit 4 inserts into the second positioning unit 6 (the sealing groove). The current collector 2 of the negative electrode, the current collector 3 of the positive electrode, and the sealing unit 4 are fixed together, for example with clamp components (such as clamp component with whorls). The current collector 2 of the negative electrode, the current collector 3 of the positive electrode, and MEA component 1 are elastomerically pressurized by using sealing unit 4. Thus there are no openings and the unit is air-tight.

In this invention, along the long edge of the fuel cell unit, the length of the proton-exchange membrane 11 combined with the length of the sealing unit 4 are less or equivalent to that of the current collectors. Thus the sealing unit 4 will not extend beyond the current collector 2 of the negative electrode or the current collector 3 of the positive electrode. The top surface of first positioning unit 5 should rise above the surface of the MEA component 1. Thus when a cell is being assembled, the sealing unit 4 first contacts the current collector 2 and the current collector 3 of the negative and positive electrodes. The height of the first positioning unit 5 should be equivalent to or slightly over-sized for the depth of the sealing groove 6 of the current collectors. Thus the proton-exchange membrane 11 can avoid being pressed by the sealing unit 4, the current collector 2, and the current collector 3.

As shown in FIG. 4, Embodiment 2 of this invention is illustrated. The difference between this embodiment and Embodiment 1 is that the first positioning unit 5′ is convex in shape with an arc-shaped cross-section, and the second positioning unit 6′ is a sealing groove with an arc-shaped cross section.

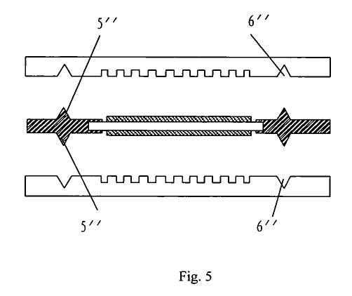

As shown in FIG. 5, Embodiment 3 of this invention is illustrated. The difference between this embodiment and Embodiment 1 is that the first positioning unit 5″ is a triangularly-shaped convex, and the second positioning unit 6″ is a triangularly-shaped sealing groove. Alternatively, said first positioning unit can also be rectangular-in-shape or polygonal-in-shape, and the second positioning unit can be a corresponding rectangular or polygonal sealing groove.

Note that the first positioning unit has been described as a convex or raised shape and the second positioning unit has been described as a corresponding groove. It should be noted that the opposite can be true where the first positioning unit is the corresponding groove and the second positioning unit is the raised shape.

While the present invention has been described with reference to certain preferred embodiments, it is to be understood that the present invention is not limited to such specific embodiments. Rather, it is the inventor's contention that the invention be understood and construed in its broadest meaning as reflected by the following claims. Thus, these claims are to be understood as incorporating not only the preferred embodiments described herein but all those other and further alterations and modifications as would be apparent to those of ordinary skilled in the art.

1. A sealed fuel cell unit comprising a MEA component, a sealing unit, and a current collector for a positive electrode and a current collector for a negative electrodes, wherein said MEA component comprising a proton-exchange membrane, the positive electrode, and the negative electrode, both the positive electrode and negative electrode attached to side of the membrane, said sealing unit covering the edges of the proton-exchange membranes comprising:
a first positioning unit located on a side of said sealing unit and facing a corresponding current collector; and
a second positioning unit located on the corresponding current collector positioned to match the first positioning unit.

2. The sealed fuel cell unit of claim 1 wherein said first and second positioning units correspond in shape.

3. The sealed fuel cell unit of claim 1 wherein said first positioning unit is convex in shape on the surface of the sealing unit, and the second positioning unit is a sealing groove on the surface of a current collector.

4. The sealed fuel cell unit of claim 3 wherein the convex shape is arc-shaped, polygonal shaped, elliptical shaped, or subulate shaped, and the sealing groove is of a matching shape.

5. The sealed fuel cell unit of claim 3 wherein the first positioning unit rises above the surface of the MEA component.

6. The sealed fuel cell unit of claim 3 wherein the first positioning unit is slightly over-sized for the sealing groove.

7. The sealed fuel cell unit of claim 1 wherein said negative and positive electrodes are made from porous carbon paper or carbon cloth, and along the long edge of the proton-exchange membrane, the proton-exchange membrane is longer than the porous carbon paper or carbon cloth by 0.1%-80%.

8. The sealed fuel cell unit of claim 1 wherein said sealing unit is an elastomer.

9. The sealed fuel cell unit of claim 1 wherein said MEA component and said sealing unit are bound together.

10. The sealed fuel cell unit of claim 1 wherein edges of the proton-exchange membrane are fixed in a groove of the sealing unit.

11. A sealed fuel cell unit comprising a MEA component, a sealing unit, and a current collector for a positive electrode and a current collector for a negative electrodes, wherein said MEA component comprising a proton-exchange membrane, the positive electrode, and the negative electrode, both the positive electrode and negative electrode attached to side of the membrane, said sealing unit covering the edges of the proton-exchange membranes and having a first positioning unit located on each side of said sealing unit and each first positioning unit faces a corresponding current collector, and a second positioning unit located on the corresponding current collector positioned to match the first positioning unit, wherein:
said first and second positioning units correspond to each other in shape;
said first and positioning unit is convex in shape on the surface of the sealing unit, and the second positioning unit is a sealing groove on the surface of a corresponding current collector;
said first positioning unit rises above the surface of the MEA component;
said first positioning unit is slightly over-sized for the sealing groove;
said negative and positive electrodes are made from porous carbon paper or carbon cloth, and along the long edge of the proton-exchange membrane, the proton-exchange membrane is longer than the porous carbon paper or carbon cloth by 0.1%-80%;
said sealing unit is an elastomer;
said MEA component and said sealing unit are bound together; and
said edges of the proton-exchange membrane are fixed in a groove of the sealing unit.
